(19) United States
(12) Patent Application Publication
(10) Pub. No.: US 2024/0399925 A1
(43) Pub. Date: Dec. 5, 2024

(54) MOTOR CONTROL SYSTEM FOR ELECTRIC VEHICLE, AND ELECTRIC VEHICLE

(71) Applicant: SUBARU CORPORATION, Tokyo (JP)

(72) Inventors: Ryo KIKKAWA, Tokyo (JP); Tomoyuki OKADA, Tokyo (JP)

(21) Appl. No.: 18/718,499

(22) PCT Filed: Nov. 16, 2022
(86) PCT No.: PCT/JP2022/042527

§ 371 Date: Jun. 11, 2024

(51) Int. Cl. B60L 58/16

(52) U.S. Cl. CPC B60L 58/16

(57) ABSTRACT

A motor control system for an electric vehicle includes: a battery; a motor including a rotor and a stator; two inverter circuits that are each coupled to the stator and are each configured to control driving and regeneration of the motor, and a control apparatus configured to control driving of the two inverter circuits. The control apparatus is configured to cause the battery to discharge by driving the respective two inverter circuits and applying, to the rotor, rotational torques in directions opposite to each other, and execute a deterioration diagnosis process of the battery, based on an output current or an output voltage of the battery upon the discharging.

### TECHNICAL FIELD

The disclosure relates to a motor control system for an electric vehicle, and an electric vehicle.

### BACKGROUND ART

An electric vehicle includes a driving motor as a driving source of the vehicle. A battery mounted on such an electric vehicle is deteriorated with repeated use. The deteriorated battery can, for example, fail to supply necessary electric power to the driving motor upon acceleration of the vehicle, or shorten a cruising distance of the vehicle due to a decrease in the maximum charging capacity of the battery. Accordingly, various techniques have been proposed for diagnosis of deterioration of a battery.

Here, a method has been known that determines a degree of deterioration of a battery by measuring internal impedance (internal resistance) of the battery. For example, Patent Literature 1 discloses a technique of calculating a degree of deterioration of a battery using an increase rate of internal resistance of the battery in a power storage system including the battery.

### CITATION LIST

### Patent Literature

Patent Literature 1: Japanese Unexamined Patent Application Publication No. 2016-105672

### SUMMARY OF INVENTION

### Problem to be Solved by the Invention

To measure internal impedance of a battery, however, it is necessary to perform charging and discharging of the battery. To perform charging and discharging of a battery that supplies electric power to a motor in an electric vehicle, it is necessary to cause the motor to output a driving torque or to regeneratively drive the motor. A timing of diagnosing a degree of deterioration of the battery is limited to a timing during traveling of the vehicle. It is also conceivable to couple a discharging device to a system separately from the motor to cause the battery to discharge, but it is necessary to provide a load device for discharging in order to diagnose the degree of deterioration of the battery.

The disclosure has been made in view of the above-described issue, and it is an object of the disclosure to provide an electric vehicle motor control system and an electric vehicle that make it possible to increase a degree of freedom of an execution timing of deterioration diagnosis of a battery that supplies electric power to a motor without using a load device for discharging.

### Means for Solving the Problem

To solve the above-described problem, an aspect of the disclosure provides a motor control system for an electric vehicle, and an electric vehicle including the motor control system. The motor control system includes a battery, a motor, two inverter circuits, and a control apparatus. The motor includes a rotor and a stator. The two inverter circuits are each coupled to the stator and are each configured to control driving and regeneration of the motor. The control apparatus is configured to control driving of the two inverter circuits. The control apparatus is configured to cause the battery to discharge by driving the respective two inverter circuits and applying, to the rotor, rotational torques in directions opposite to each other, and execute a deterioration diagnosis process of the battery, based on an output current or an output voltage of the battery upon the discharging.

### Effects of the Invention

As described above, according to the disclosure, it is possible to increase a degree of freedom of an execution timing of deterioration diagnosis of a battery that supplies electric power to a motor without using a load device for discharging.

### BRIEF DESCRIPTION OF DRAWINGS

FIG. 1 is a schematic diagram illustrating a configuration example of a vehicle mounted with a motor control system according to an embodiment of the disclosure.

FIG. 2 is a circuit diagram illustrating a drive circuit of a motor of the motor control system according to the embodiment.

FIG. 3 is a block diagram illustrating a configuration example of a control apparatus of the motor control system according to the embodiment.

FIG. 4 is an explanatory diagram illustrating an example of a method of a battery deterioration diagnosis process by the motor control system according to the embodiment.

FIG. 5 is a flowchart illustrating an operation example of the battery deterioration diagnosis process by the motor control system according to the embodiment.

FIG. 6 is a flowchart illustrating an operation example of a warm-up process before a start of travel by the motor control system according to the embodiment.

FIG. 7 is a flowchart illustrating an operation example of a warm-up process after the start of travel by the motor control system according to the embodiment.

FIG. 8 is a flowchart illustrating an operation example of the warm-up process after the start of travel by the motor control system according to the embodiment.

### MODES FOR CARRYING OUT THE INVENTION

In the following, a preferred embodiment of the disclosure is described in detail with reference to the accompanying drawings. It is to be noted that, throughout the present description and the drawings, elements having substantially the same function and configuration are denoted with the same reference numerals to avoid any redundant description.

### <1. Configuration of Motor Control System for Electric Vehicle>

Description is given first of an example of a configuration of a motor control system for an electric vehicle according to an embodiment of the disclosure.

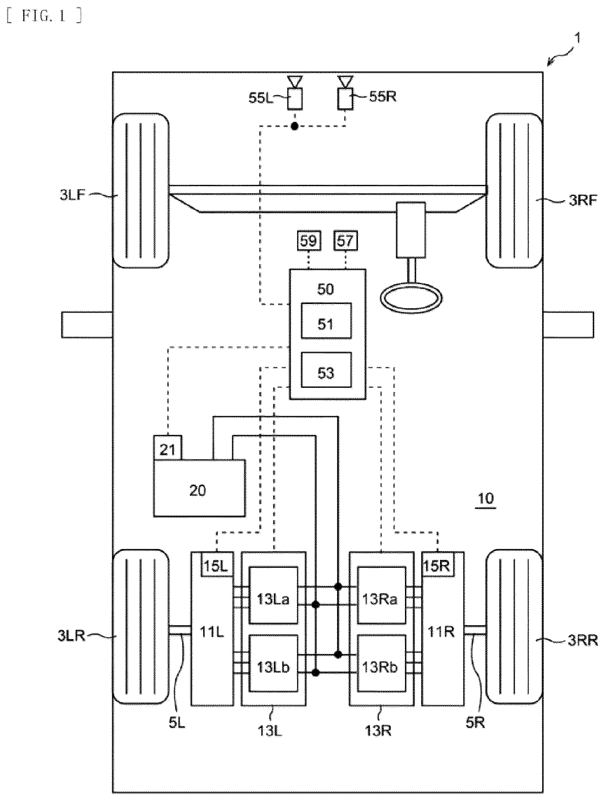

FIG. 1 is a schematic diagram illustrating a configuration example of a vehicle (electric vehicle) 1 mounted with a motor control system 10 according to the present embodiment. As illustrated in the figure, the vehicle 1 is a four-wheel automobile including a left front wheel 3LF, a right front wheel 3RF, a left rear wheel 3LR, and a right rear wheel 3RR (hereinafter, the left front wheel 3LF and the right front wheel 3RF are collectively referred to as “front wheels 3F”, and the left rear wheel 3LR and the right rear wheel 3RR are collectively referred to as “rear wheels 3R”, in some cases). The vehicle 1 is configured as a rear-wheel drive vehicle including a first motor 11L and a second motor 11R as driving force sources that generate a driving torque for the vehicle 1. The first motor 11L and the second motor 11R independently drive the left rear wheel and the right rear wheel, respectively.

The motor control system 10 includes the first motor 11L, the second motor 11R, a first inverter unit 13L, a second inverter unit 13R, a battery 20, a cooling water circuit 30, and a control apparatus 50. As the first motor 11L and the second motor 11R, for example, a three-phase AC radial motor or an axial gap motor is used. However, the number of phases is not particularly limited. The first motor 11L outputs a driving torque to be transmitted to the left rear wheel 3LR via a left rear wheel drive shaft 5L. The second motor 11R outputs a driving torque to be transmitted to the right rear wheel 3RR via a right rear wheel drive shaft 5R.

In addition, the first motor 11L and the second motor 11R have functions of receiving rotational torques of the rear wheels 3R transmitted, respectively, via the left rear wheel drive shaft 5L and the right rear wheel drive shaft 5R to perform regenerative power generation during deceleration of the vehicle 1. Driving and regeneration of the first motor 11L and the second motor 11R are controlled by the control apparatus 50. The first motor 11L and the second motor 11R each have a determined rated output torque at which a stable torque is configured to be outputted continuously.

The first motor 11L includes a first motor temperature sensor 15L. The second motor 11R includes a second motor temperature sensor 15R. The first motor temperature sensor 15L and the second motor temperature sensor 15R detect temperatures of the respective motors, and transmit information on the detected temperatures to the control apparatus 50.

The battery 20 includes multiple battery cells which are each a chargeable and dischargeable secondary battery. The battery 20 may be, for example, a lithium-ion battery having a rated voltage of 200 V, but the rated voltage and the type of the battery 20 are not particularly limited.

The battery 20 is coupled to the first motor 11L and the second motor 11R via the first inverter unit 13L and the second inverter unit 13R, and stores electric power to be supplied to the first motor 11L and the second motor 11R. The battery 20 includes a battery management device 21. The battery management device 21 detects, for example, a remaining capacity, an output current, an output voltage, and a battery temperature of the battery 20, and transmits the remaining capacity, the output current, the output voltage, and the battery temperature to the control apparatus 50.

The first inverter unit 13L may control the driving and the regeneration of the first motor 11L. In the present embodiment, the first inverter unit 13L includes a first inverter circuit 13La and a second inverter circuit 13Lb, and controls the first motor 11L by the two inverter circuits 13La and 13Lb. Each of the first inverter circuit 13La and the second inverter circuit 13Lb converts DC power swept from the battery 20 into three-phase AC power, and supplies the three-phase AC power to a stator of the first motor 11L. In addition, each of the first inverter circuit 13La and the second inverter circuit 13Lb converts three-phase AC power regenerated by the first motor 11L into DC power, and charges the battery 20. Driving of the first inverter unit 13L is controlled by the control apparatus 50.

The second inverter unit 13R controls the driving and the regeneration of the second motor 11R. In the present embodiment, the second inverter unit 13R includes a first inverter circuit 13Ra and a second inverter circuit 13Rb, and controls the second motor 11R by the two inverter circuits 13Ra and 13Rb. Each of the first inverter circuit 13Ra and the second inverter circuit 13Rb converts DC power swept from the battery 20 into three-phase AC power, and supplies the three-phase AC power to a stator of the second motor 11R. In addition, each of the first inverter circuit 13Ra and the second inverter circuit 13Rb converts three-phase AC power regenerated by the second motor 11R into DC power, and charges the battery 20. Driving of the second inverter unit 13R is controlled by the control apparatus 50.

The control apparatus 50 serves as a device that controls the driving of the first motor 11L and the second motor 11R by one or more processors executing a computer program. The computer program is a computer program that causes a processor to execute an operation described later to be executed by the control apparatus 50. The computer program to be executed by the processor may be recorded in a recording medium that serves as a storage (memory) 53 provided in the control apparatus 50, or may be recorded in a recording medium built in the control apparatus 50 or any recording medium externally attachable to the control apparatus 50.

The recording medium to record the computer program may be: a magnetic medium such as a hard disk, a floppy disk, or a magnetic tape: an optical recording medium such as a CD-ROM (Compact Disk Read Only Memory), a DVD (Digital Versatile Disk), an SSD (Solid State Drive), or a Blu-ray (Registered Trademark): a magneto-optic medium such as a floptical disk: a storage device such as a RAM or a ROM: a flash memory such as a USB (Universal Serial Bus) memory: or any other medium configured to contain a program.

To the control apparatus 50, the first motor temperature sensor 15L, the second motor temperature sensor 15R, the battery management device 21, a surrounding environment sensor 55, a vehicle state sensor 57, and a GNSS (Global Navigation Satellite System) sensor 59 are coupled via a dedicated line or a communication means such as CAN (Controller Area Network) or LIN (Local Interconnect Network). In addition, to the control apparatus 50, the first inverter unit 13L and the second inverter unit 13R are coupled via the dedicated line or the communication means such as the CAN or the LIN. The function and configuration of the control apparatus 50 are described in detail later.

The surrounding environment sensor 55 detects a surrounding environment of the vehicle 1. In the present embodiment, the surrounding environment sensor 55 is configured to detect at least a road shape ahead of the vehicle 1. In the present embodiment, the vehicle 1 is provided with front imaging cameras 55LF and 55RF as the surrounding environment sensor 55. The front imaging cameras 55LF and 55RF perform imaging of a region ahead of the vehicle 1 to generate image data. The front imaging cameras 55LF and 55RF include an image sensor such as CCD (Charged-Coupled Devices) or CMOS (Complementary Metal-Oxide-Semiconductor), and transmit the generated image data to the control apparatus 50. In the vehicle 1 illustrated in FIG. 1, the front imaging cameras 55LF and 55RF are configured as a stereo camera including the pair of left and right cameras, but may be a monocular camera. The vehicle 1 may include, in addition to the front imaging cameras 55LF and 55RF, any one or more of sensors of LiDAR (Light Detection And Ranging), a radar sensor such as a millimeter-wave radar, or an ultrasonic sensor.

The vehicle state sensor 57 includes one or more sensors that detect an operation state and a behavior of the vehicle 1. The vehicle state sensor 57 includes an accelerator position sensor that detects at least accelerator opening and a vehicle speed sensor that detects a vehicle speed. Additionally, the vehicle state sensor 57 may include, for example, a steering angle sensor, a brake stroke sensor, or a brake pressure sensor. In addition, the vehicle state sensor 57 may further include, for example, an acceleration rate sensor, an angular velocity sensor, or both. The vehicle state sensor 57 transmits a sensor signal including the detected information to the control apparatus 50.

The GNSS sensor 59 receives a satellite signal transmitted from multiple satellites to detect the position of the GNSS sensor 59, i.e., the position of the vehicle 1. The GNSS sensor 59 transmits information on the detected position of the vehicle 1 to the control apparatus 50.

### <2. Configuration of Drive Circuit of Motor>

Description is given next of a configuration of a drive circuit of the motor of the motor control system according to the present embodiment.

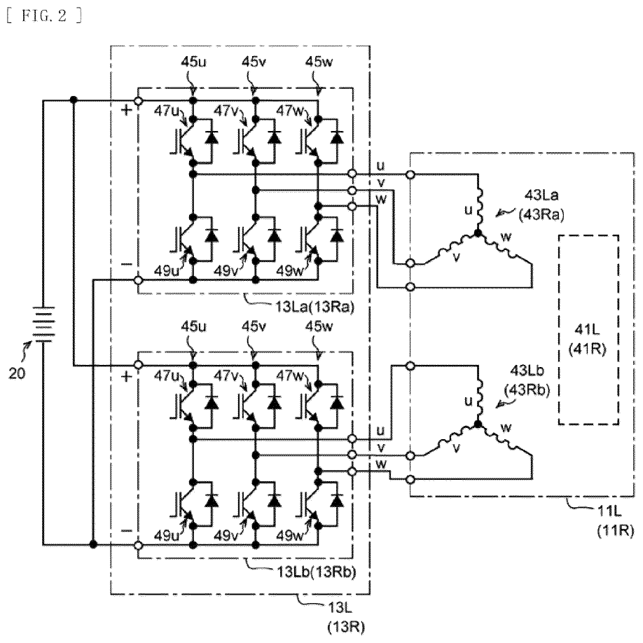

FIG. 2 is a circuit diagram of a drive circuit of the first motor 11L and the second motor 11R. The drive circuit of the first motor 11L and the drive circuit of the second motor 11R have the same configuration. Thus, FIG. 2 illustrates the drive circuit of one motor.

In the present embodiment, the first motor 11L includes one rotor 41L and two sets of three-phase stator coils 43La and 43Lb. Likewise, the second motor 11R includes one rotor 41R and two sets of three-phase stator coils 43Ra and 43Rb. When the motor is a single-stator radial motor, two sets of three-phase stator coils insulated from each other are assembled to one stator. In addition, when the motor is a double-stator axial gap motor, a three-phase stator coil is assembled to each of two stators arranged on both axial sides of the rotor.

The first inverter circuit 13La (13Ra) and the second inverter circuit 13Lb (13Rb) each include multiple switching devices. Driving of the respective switching devices of the first inverter circuit 13La (13Ra) and the second inverter circuit 13Lb (13Rb) is controlled by the control apparatus 50.

The first inverter circuit 13La (13Ra) is electrically coupled to the first stator coil 43La (43Ra) of the first motor 11L (second motor 11R). The first inverter circuit 13La (13Ra) includes three arm circuits 45u, 45v, and 45w (hereinafter, collectively referred to simply as arm circuits 45 unless distinction is particularly necessary). The arm circuit 45u is electrically coupled to a u-phase coil of the first stator coil 43La (43Ra) of the first motor 11L (second motor 11R). The arm circuit 45v is electrically coupled to a v-phase coil of the first stator coil 43La (43Ra) of the first motor 11L (second motor 11R). The arm circuit 45w is electrically coupled to a w-phase coil of the first stator coil 43La (43Ra) of the first motor 11L (second motor 11R).

Each of the arm circuits 45 includes an upper arm on an upstream side of the current and a lower arm on a downstream side of the current. The upper arm is electrically coupled to a positive electrode side of the battery 20, and the lower arm is electrically coupled to a negative electrode side of the battery 20. The upper arm and the lower arm of the respective arm circuits 45 include switching devices 47u, 49u, 47v, 49v, 47w, and 49w to each of which a diode is electrically coupled in anti-parallel. The switching devices 47u, 49u, 47v, 49v, 47w, and 49w may be, for example, a MOSFET (Metal Oxide Semiconductor Field Effect Transistor) or an IGBT (Insulated Gate Bipolar Transistor). However, the switching devices 47u, 49u, 47v, 49v, 47w, and 49w may also be another switching device.

In the first motor 11L (second motor 11R), driving the first inverter circuit 13La (13Ra) and the second inverter circuit 13Lb (13Rb) causes supply of three-phase AC power to one or both of the first stator coil 43La (43Ra) and the second stator coil 43Lb (43Rb), whereby the rotor 41L (41R) is rotationally driven to output a driving torque. In addition, in the first motor 11L (second motor 11R), driving the first inverter circuit 13La (13Ra) and the second inverter circuit 13Lb (13Rb) causes supply of regenerative power generated by one or both of the first stator coil 43La (43Ra) and the second stator coil 43Lb (43Rb) to the battery 20.

It is to be noted that a converter circuit that boosts a voltage may be provided between the battery 20 and each inverter circuit.

### <3. Control Apparatus>

Next, description is given in detail of a configuration of the control apparatus 50.

It is to be noted that, in the following description, rotation of the first motor 11L and the second motor 11R in a forward direction of the vehicle 1 is referred to as “forward rotation” and rotation of the first motor 11L and the second motor 11R in a backward direction of the vehicle 1 is referred to as “counter-rotation”.

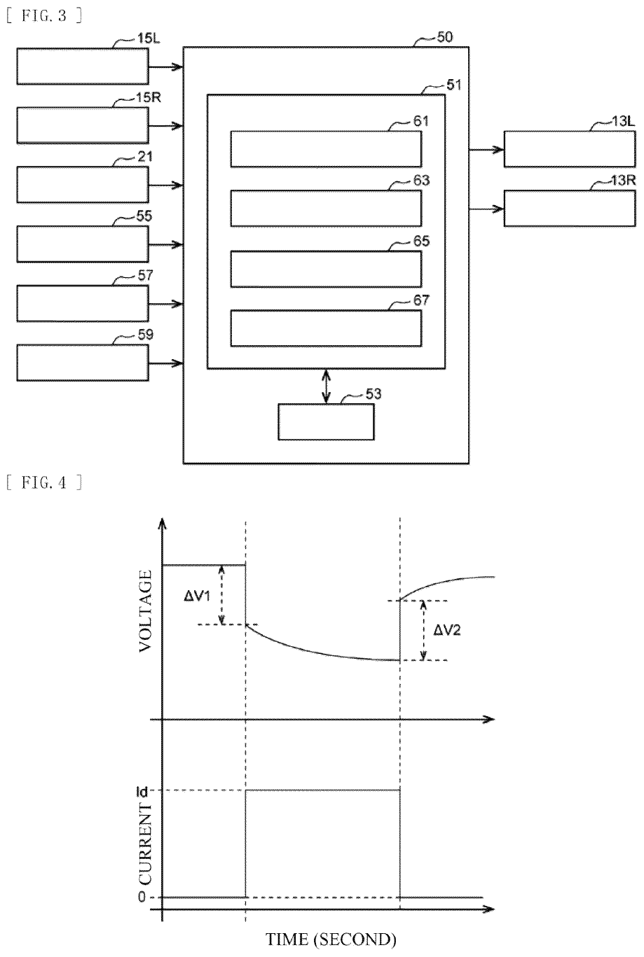

FIG. 3 is a block diagram illustrating the function and configuration of the control apparatus 50 of the motor control system 10 according to the present embodiment.

The control apparatus 50 includes a processing unit 51 and a storage 53. The processing unit 51 includes one or more processors such as a CPU. All or a part of the processing unit 51 may include updatable one such as firmware, or may be, for example, a program module to be executed by a command from, for example, a CPU. The storage 53 includes a memory such as a RAM (Random Access Memory), a ROM (Read Only Memory), or an SSD (Solid State Drive).

However, the number and the type of the storages 53 are not particularly limited. The storage 53 stores a computer program to be executed by the processing unit 51, and information such as various parameters to be used in a process of arithmetic operation, detection data, and results of arithmetic operation.

The processing unit 51 of the control apparatus 50 includes a target torque setting unit 61, a motor controller 63, a surrounding environment detector 65, and a battery diagnosis processor 67. Each of these units may be a function to be implemented by a processor such as a CPU executing a computer program, but a part of them may be configured by an analog circuit. In the following, description is given of specific processing operations after brief description of functions of the respective units of the processing unit 51.

### (Target Torque Setting Unit)

The target torque setting unit 61 sets target torques of the first motor 11L and the second motor 11R. In the present embodiment, when a deterioration diagnosis process of the battery 20 is executed, the target torques of the first motor 11L and the second motor 11R are configured to be corrected by the battery diagnosis processor 67 described later.

Specifically, the target torque setting unit 61 sets respective target output torques of the first motor 11L and the second motor 11R based on a requested driving torque of the vehicle 1. In manual driving, the requested driving torque is calculated based on an amount of operation of an accelerator pedal and a vehicle speed. In addition, in automated driving, the requested driving torque is calculated based on a requested acceleration rate determined by arithmetic operation.

The target torque setting unit 61 basically sets a ratio between the target output torque of the first motor 11L and the target output torque of the second motor 11R to 5:5. Meanwhile, in a case of executing a torque vectoring control to enhance turning performance of the vehicle 1, the target torque setting unit 61 sets a ratio of the target output torque of the motor in a turning direction of the vehicle 1 relatively small. In this case, the target torque setting unit 61 determines the ratio between the target output torque of the first motor 11L and the target output torque of the second motor 11R, based on a steering angle and a vehicle speed, for example.

In addition, the target torque setting unit 61 determines whether to respectively drive the first motor 11L and the second motor 11R by only one of the first stator coils 43La and 43Ra or the second stator coils 43Lb and 43Rb, or whether to respectively drive the first motor 11L and the second motor 11R by both of the first stator coils 43La and 43Ra and the second stator coils 43Lb and 43Rb, in accordance with magnitudes of the respective target output torques of the first motor 11L and the second motor 11R. This makes it possible to enhance driving efficiency caused by, for example, an electric power loss and wiring resistance due to operations of the switching devices.

For example, when the target output torque is smaller than a predetermined threshold, the target torque setting unit 61 determines that the first motor 11L and the second motor 11R are to be respectively driven by only one of the first stator coils 43La and 43Ra or the second stator coils 43Lb and 43Rb. In this case, the target torque setting unit 61 sets the respective target output torques of the first motor 11L and the second motor 11R as the target output torque by one of the first stator coils 43La and 43Ra or the second stator coils 43Lb and 43Rb, and sets the target output torque of the other stator coil to zero.

Meanwhile, when the target output torque is equal to or greater than the predetermined threshold, the target torque setting unit 61 determines that the first motor 11L and the second motor 11R are to be respectively driven by both of the first stator coils 43La and 43Ra and the second stator coils 43Lb and 43Rb. In this case, the target torque setting unit 61 sets a value of one-half of each of the target output torques of the first motor 11L and the second motor 11R as the target output torque of each of the first stator coils 43La and 43Ra and the second stator coils 43Lb and 43Rb.

It is to be noted that the target torque setting unit 61 may constantly drive the first motor 11L and the second motor 11R respectively by both of the first stator coils 43La and 43Ra and the second stator coils 43Lb and 43Rb. In this case, the target torque setting unit 61 sets a value of one-half of each of the target output torques of the first motor 11L and the second motor 11R as the target output torque of each of the first stator coils 43La and 43Ra and the second stator coils 43Lb and 43Rb.

In addition, the target torque setting unit 61 sets a target regenerative torque of each of the first motor 11L and the second motor 11R based on a requested braking torque of the vehicle 1. In the manual driving, the requested braking torque is calculated based on an amount of operation of an accelerator pedal and a vehicle speed. In addition, in the automated driving, the requested driving torque is calculated based on a requested acceleration rate determined by arithmetic operation. The target torque setting unit 61 sets a ratio between the target regenerative torque of the first motor 11L and the target regenerative torque of the second motor 11R to 5:5.

In addition, the target torque setting unit 61 determines whether to regeneratively drive the first motor 11L and the second motor 11R respectively by only one of the first stator coils 43La and 43Ra or the second stator coils 43Lb and 43Rb, or whether to regeneratively drive the first motor 11L and the second motor 11R respectively by both of the first stator coils 43La and 43Ra and the second stator coils 43Lb and 43Rb, in accordance with magnitudes of the respective target regenerative torques of the first motor 11L and the second motor 11R. This makes it possible to enhance regeneration efficiency caused by, for example, an electric power loss and wiring resistance due to operations of the switching devices.

For example, when the target regenerative torque is smaller than a predetermined threshold, the target torque setting unit 61 determines that the first motor 11L and the second motor 11R are to be regeneratively driven respectively by only one of the first stator coils 43La and 43Ra or the second stator coils 43Lb and 43Rb. In this case, the target torque setting unit 61 sets the respective target regenerative torques of the first motor 11L and the second motor 11R as the target regenerative torques by one of the first stator coils 43La and 43Ra or the second stator coils 43Lb and 43Rb, and set the target regenerative torque of the other stator coil to zero.

Meanwhile, when the target regenerative torque is equal to or greater than the predetermined threshold, the target torque setting unit 61 determines that the first motor 11L and the second motor 11R are to be regeneratively driven respectively by both of the first stator coils 43La and 43Ra and the second stator coils 43Lb and 43Rb. In this case, the target torque setting unit 61 sets a value of one-half of each of the target regenerative torques of the first motor 11L and the second motor 11R as the target regenerative torque of each of the first stator coils 43La and 43Ra and the second stator coils 43Lb and 43Rb.

It is to be noted that the target torque setting unit 61 may constantly and regeneratively drive the first motor 11L and the second motor 11R respectively by both of the first stator coils 43La and 43Ra and the second stator coils 43Lb and 43Rb. In this case, the target torque setting unit 61 sets a value of one-half of each of the target regenerative torques of the first motor 11L and the second motor 11R as the target regenerative torque of each of the first stator coils 43La and 43Ra and the second stator coils 43Lb and 43Rb.

### (Motor Controller)

The motor controller 63 controls the driving of the first inverter unit 13L and the second inverter unit 13R, and controls the driving and the regeneration of the first motor 11L and the second motor 11R. Specifically, the motor controller 63 controls the driving of the first inverter unit 13L and the second motor 11R based on the target output torque and the target regenerative torque set in the first stator coils 43La and 43Ra and the second stator coils 43Lb and 43Rb of the first motor 11L and the second motor 11R, respectively.

More specifically, the motor controller 63 sets a driving duty ratio of the switching devices provided in the first inverter circuits 13La and 13Ra and the second inverter circuits 13Lb and 13Rb of the first inverter unit 13L and the second inverter circuit 13Rb, respectively, to control the operations of the switching devices. Thus, the driving torque equivalent to the target output torque is outputted from the first motor 11L and the second motor 11R. Alternatively, a braking torque equivalent to the target regenerative torque is generated by the first motor 11L and the second motor 11R.

### (Surrounding Environment Detection Unit)

The surrounding environment detector 65 detects a surrounding environment of the vehicle 1 based on detection data transmitted from the surrounding environment sensor 55. Specifically, the surrounding environment detector 65 calculates a type, a size (width, height, and depth), a position, and a speed of an obstacle present around the vehicle 1, a distance from the vehicle 1 to the obstacle, and a relative speed between the vehicle 1 and the obstacle. Examples of the obstacle to be detected include another vehicle traveling, a parked vehicle, a pedestrian, a bicycle, a sidewall, a curbstone, a building, a utility pole, a traffic sign, a traffic light, a natural object, and any other objects present around the vehicle 1. In the present embodiment, the surrounding environment detector 65 acquires information on at least a road shape ahead of the vehicle 1.

The surrounding environment detector 65 refers to high-precision map data to acquire the information on a road shape ahead in a traveling direction of the vehicle 1 based on information on the position of the vehicle 1. Specifically, the surrounding environment detector 65 identifies the position and the traveling direction of the vehicle 1 on the high-precision map data based on the information on the position of the vehicle 1 transmitted from the GNSS sensor 59 to acquire the information on the road shape ahead in the traveling direction of the vehicle 1. The high-precision map data is recorded in association with data regarding the gradient and the radius of curvature of the road, and the surrounding environment detector 65 acquires these pieces of information on the road shape.

### (Battery Diagnostic Processor)

The battery diagnosis processor 67 executes the deterioration diagnosis process of the battery 20. In the present embodiment, the battery diagnosis processor 67 drives each of the first inverter circuits 13La and 13Ra and the second inverter circuits 13Lb and 13Rb of the first inverter unit 13L and the second inverter unit 13R to apply rotational torques in directions opposite to each other to the rotors 41L and 41R of the first motor 11L and the second motor 11R. The battery diagnosis processor 67 causes the battery 20 to discharge by executing the above-described process of applying the rotational torques in opposite directions (hereinafter, also referred to as “counter-torque driving”). The battery diagnosis processor 67 executes the deterioration diagnosis process of the battery 20 based on the output current or the output voltage of the battery 20 upon the discharging.

Description is given by exemplifying the drive circuit of the motor illustrated in FIG. 2. The battery diagnosis processor 67 controls the driving of the first inverter unit 13L (second inverter unit 13R) to allow the rotational torque to be applied to the rotor 41L (41R) by the first stator coil 43La (43Ra) of the first motor 11L (second motor 11R) and the rotational torque to be applied to the rotor 41L (41R) by the second stator coil 43Lb (43Rb) to be in directions opposite to each other. Thus, a value of a current to be supplied to the first stator coil 43La (43Ra) and the second stator coil 43Lb (43Rb) of the first motor 11L (second motor 11R) increases by an amount corresponding to cancellation of the rotational torques. Accordingly, it is possible to instantaneously change the output current and the output voltage from the battery 20 without changing the first motor 11L (11R) and thus to execute deterioration diagnosis of the battery 20 based on the output current or the output voltage.

FIG. 4 is an explanatory diagram illustrating an example of the deterioration diagnosis process of the battery 20.

The battery 20 has internal resistance Rb. The internal resistance Rb increases as the battery 20 deteriorates. Accordingly, evaluating a value of the internal resistance Rb enables a degree of deterioration of the battery 20 to be diagnosed. For example, as illustrated in FIG. 4, a current of a predetermined magnitude is discharged from the battery 20, thus enabling the value of the internal resistance Rb to be determined based on a variable value of the output voltage (terminal voltage) at that time.

Specifically, when a value of the current to be discharged for the deterioration diagnosis of the battery 20 is defined as Id, a voltage variation amount at the start of the discharging is defined as ΔV1, and a voltage variation amount at the end of the discharging is defined as ΔV2, the internal resistance Rb is able to be determined as ΔV1/Id or ΔV2/Id. Data allowing for determination of a relationship between the value of the internal resistance Rb and the degree of deterioration of the battery 20 is stored in advance in the storage 53, and the data is referred to, thereby making it possible to estimate the degree of deterioration corresponding to the internal resistance Rb. For example, when the estimated internal resistance Rb is equal to or greater than a predetermined threshold, the battery diagnosis processor 67 may determine that the battery 20 is deteriorated. However, a method for the deterioration diagnosis of the battery 20 is not limited to the example illustrated in FIG. 4, and another method may be adopted as long as the method enables determination of deterioration of the battery 20 by causing the battery 20 to discharge.

In the present embodiment, when executing the deterioration diagnosis process of the battery 20, the battery diagnosis processor 67 adds output torques, which have the same absolute value in directions opposite to each other, to the target output torques, which is set by the target torque setting unit 61, of one or both of the first stator coils 43La and 43Ra and the second stator coils 43Lb and 43Rb of the first motor 11L or the second motor 11R. Thus, the respective target output torques are corrected. For example, an output torque of a predetermined magnitude in a forward rotation direction is added to the target output torque of the first stator coil 43La (43Ra), and an output torque of the same magnitude in a counter-rotation direction is added to the target output torque of the second stator coil 43Lb (43Rb). This makes it possible to instantaneously change the output current and the output voltage from the battery 20 without changing the driving torque outputted from the first motor 11L (second motor 11R).

The deterioration diagnosis process of the battery 20 is executed by instantaneously changing the output current and the output voltage from the battery 20 in a state where the target output torque of the first motor 11L (second motor 11R) is constant. That is, the battery diagnosis processor 67 diagnoses the deterioration of the battery 20 based on a magnitude of the variation of the output current or the output voltage at the time when the output current and the output voltage are instantaneously changed in a state where the output current and the output voltage from the battery 20 are constant. This makes it possible to accurately detect an amount of the instantaneous change in the output current or the output voltage from the state where the output current or the output voltage of the battery 20 is stable and thus to accurately determine the degree of deterioration of the battery 20.

For example, after the motor control system 10 has been activated and before the vehicle 1 starts to travel, the target output torques of the first motor 11L and the second motor 11R are both in a state of zero. Accordingly, the battery diagnosis processor 67 applies the rotational torques of the same magnitude in directions opposite to each other to the rotor 41L (41R) to thereby cause the battery 20 to discharge while maintaining the output torque of the first motor 11L (second motor 11R) at zero. In this case, the battery diagnosis processor 67 sets the sum of the rotational torque to be applied to the rotor 41L (41R) by the first stator coil 43La (43Ra) and the rotational torque to be applied to the rotor 41L (41R) by the second stator coil 43Lb (43Rb) to zero. This makes it possible to cause the battery 20 to discharge without generating driving force in the vehicle 1.

Meanwhile, after the vehicle 1 has started to travel, a state where the target output torque of the first motor 11L or the second motor 11R is constant for a predetermined period of time is predicted, and the first motor 11L or the second motor 11R is counter-torque driven during a period when the target output torque is constant for a predetermined period of time or longer. At that time, the battery diagnosis processor 67 allows the sum of the rotational torque to be applied to the rotor 41L (41R) by the first stator coil 43La (43Ra) and the rotational torque to be applied to the rotor 41L (41R) by the second stator coil 43Lb (43Rb) to coincide with the target output torque of the first motor 11L (second motor 11R). This makes it possible to instantaneously change the output current and the output voltage from the battery 20 while outputting a driving torque equivalent to the requested driving torque of the vehicle 1.

For example, the battery diagnosis processor 67 adds (subtracts) a constant counter-rotational torque to (from) the target output torque of the first stator coil 43La (43Ra), and adds, to the target output torque of the second stator coil 43Lb (43Rb), a forward rotational torque that cancels the counter-rotational torque. Alternatively, the battery diagnosis processor 67 adds (subtracts) a constant counter-rotational torque to (from) the target output torque of the second stator coil 43Lb (43Rb), and adds, to the target output torque of the first stator coil 43La (43Ra), a forward rotational torque that cancels the counter-rotational torque. However, the method of setting the respective rotational torques to be applied to the rotor 41L (41R) by the first stator coil 43La (43Ra) and the second stator coil 43Lb (43Rb) is not limited to the example described above.

The predetermined period of time used for determination of the state where the target output torque is constant is set to any value equal to or longer than the time during which the motor is counter-torque driven for the deterioration diagnosis of the battery 20. In the present embodiment, the battery diagnosis processor 67 determines that the target output torque is constant for a predetermined period of time or longer when it is predicted that the vehicle 1 travels straight for a predetermined period of time or longer and that one of an acceleration rate and a deceleration rate of the vehicle 1 does not change, based on the road shape ahead in the traveling direction of the vehicle 1 detected by the surrounding environment detector 65 during automated driving of the vehicle 1. Alternatively, the battery diagnosis processor 67 may determine that the target output torque is constant for a predetermined period of time or longer when it is predicted that the vehicle 1 travels straight for a predetermined period of time or longer and that one of the acceleration rate and the deceleration rate of the vehicle 1 does not change, based on the information on the position of the vehicle 1 acquired from the GNSS sensor 59 and the information on the road shape and the speed limit in map data during the automated driving of the vehicle 1.

When executing the deterioration diagnosis of the battery 20, the battery diagnosis processor 67 may counter-torque drive one of the first motor 11L or the second motor 11R, or may counter-torque drive both of the first motor 11L and the second motor 11R. For example, the battery diagnosis processor 67 counter drives one or both of the first motor 11L and the second motor 11R in accordance with a predetermined diagnosing current value necessary for the deterioration diagnosis set in advance. For example, when a value of a current to be instantaneously discharged from the battery 20 is desired to be increased, the battery diagnosis processor 67 counter-torque drives both of the first motor 11L and the second motor 11R. In addition, when the value of the current to be instantaneously discharged from the battery 20 may be small, the battery diagnosis processor 67 counter-torque drives one of the first motor 11L or the second motor 11R. This makes it possible to reduce an electric power loss caused by the driving of the switching devices of the first inverter circuits 13La and 13Ra and the second inverter circuits 13Lb and 13Rb.

Alternatively, the battery diagnosis processor 67 may vary a ratio of currents to be supplied to the first motor 11L and the second motor 11R in accordance with the temperatures of the first motor 11L and the second motor 11R. For example, when a current value to be increased for the deterioration diagnosis of the battery 20 is defined as Id, when a temperature Tm1 of the first motor 11L outputted from the first motor temperature sensor 15L and a temperature Tm2 of the second motor 11R outputted from the second motor temperature sensor 15R are both less than a predetermined reference temperature TO, the ratio of the currents to be supplied to the first motor 11L and the second motor 11R is set to 5:5. This makes it possible to discharge a current necessary for the deterioration diagnosis of the battery 20 while suppressing an increase in the respective temperatures of the first motor 11L and the second motor 11R. Meanwhile, when one of the temperature Tm1 of the first motor 11L or the temperature Tm2 of the second motor 11R is equal to or higher than the predetermined reference temperature TO, a rate of the current to be supplied to the motor having a lower temperature is set to 10. This suppresses a further increase in the temperature of the motor having a high temperature.

In addition, when the remaining capacity of the battery 20 is equal to or greater than a predetermined threshold, the battery diagnosis processor 67 may execute a process of applying rotational torques in directions opposite to each other to the rotor 41L (41R) to execute the deterioration diagnosis of the battery 20. This makes it possible to prevent a decrease in the remaining capacity of the battery 20 as a result of the deterioration diagnosis process of the battery 20 and thus to prevent the charge of the battery 20 from being exhausted or a cruising distance from being short.

### 4. Process Operation Example

The description has been given heretofore of a configuration example of the motor control system 10 according to the present embodiment. Next, description is given of an example of an operation of a battery deterioration diagnosis process by the control apparatus 50 of the motor control system 10 with reference to flowcharts.

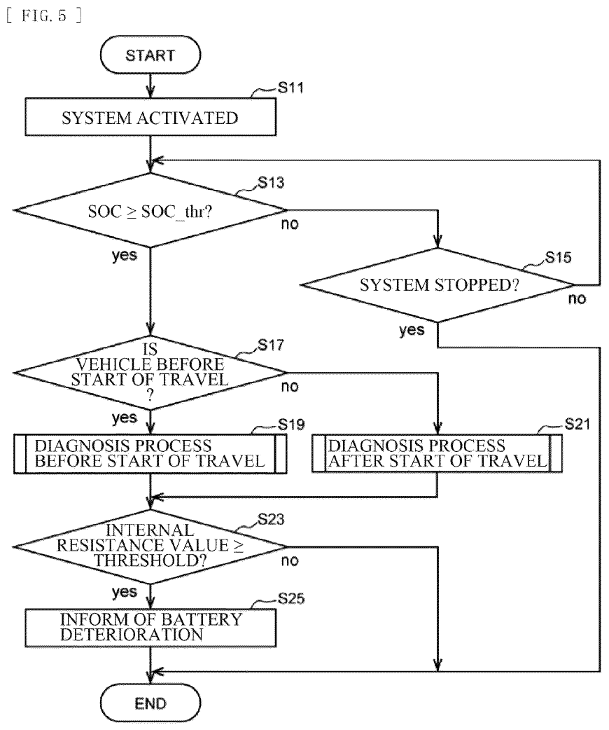

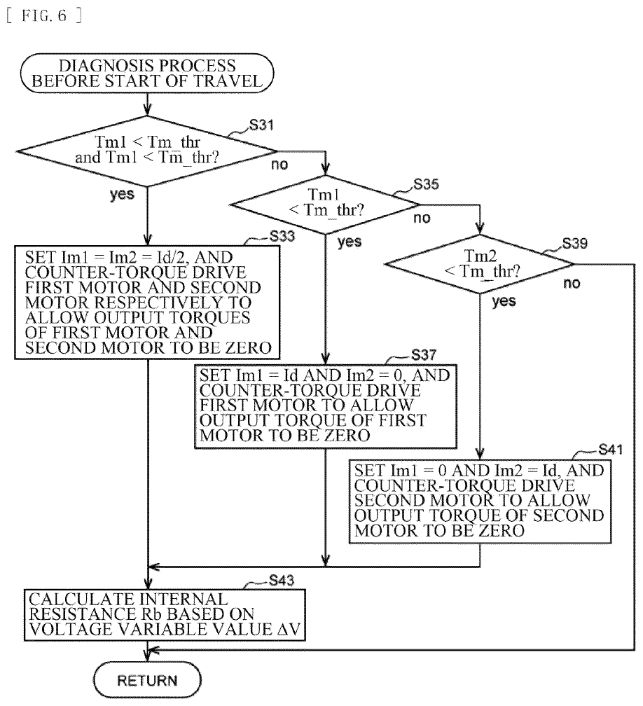

FIG. 5 is a flowchart illustrating an example of the operation of the battery deterioration diagnosis process by the control apparatus 50 according to the present embodiment.

First, when a drive system for the vehicle 1 is activated (step S11), the battery diagnosis processor 67 of the processing unit 51 determines whether a remaining capacity SOC of the battery 20 is equal to or greater than a predetermined threshold SOC_thr (step S13). Specifically, the battery diagnosis processor 67 acquires information on the remaining capacity SOC of the battery 20 transmitted from the battery management device 21, and determines whether the remaining capacity SOC is equal to or greater than the predetermined threshold SOC_thr. Here, determination is made as to whether the counter-torque driving is in a state of being executable on the rotors 41L and 41R without causing insufficient output of the battery 20. The predetermined threshold SOC_thr may be determined in accordance with a set value of a rotational torque to be canceled by the counter-torque driving. That is, a greater set value of the rotational torque to be canceled causes the output current of the battery 20 to be outputted in the counter-torque driving to be greater, and accordingly the predetermined threshold SOC_thr is set to a greater value.

If determination is not made that the remaining capacity SOC of the battery 20 is equal to or greater than the predetermined threshold SOC_thr (S13/No), the battery diagnosis processor 67 determines whether the motor control system 10 has been stopped (step S15). If determination is made that the motor control system 10 has been stopped (S15/Yes), the deterioration diagnosis process of the battery 20 is ended. Meanwhile, if determination is not made that the motor control system 10 has been stopped (S15/No), the battery diagnosis processor 67 repeatedly executes the determination in step S13.

If determination is made that the remaining capacity SOC of the battery 20 is equal to or greater than the predetermined threshold SOC_thr (S13/No), the battery diagnosis processor 67 determines whether the vehicle 1 is in a state before the start of travel (step S17). For example, if the requested driving torque calculated based on information on the accelerator opening or the requested acceleration rate is not a positive value exceeding zero after the activation of the motor control system 10, the battery diagnosis processor 67 may determine that the vehicle 1 is in a state before the start of travel. However, the method of determining whether the vehicle 1 is in a state before the start of travel is not limited to the example described above.

If determination is made that the vehicle 1 is in a state before the start of travel (S17/Yes), the battery diagnosis processor 67 executes a diagnosis process before the start of travel (step S19). Meanwhile, if determination is not made that the vehicle 1 is in a state before the start of travel (S17/No), the battery diagnosis processor 67 executes a diagnosis process after the start of travel (step S21).

FIG. 6 is a flowchart illustrating an example of the diagnosis process before the start of travel.

In a state before the start of travel of the vehicle 1, the first motor 11L, the second motor 11R, or both are counter-torque driven not to allow a driving torque to be outputted from the first motor 11L and the second motor 11R.

The battery diagnosis processor 67 determines whether the temperature Tm1 of the first motor 11L and the temperature Tm2 of the second motor 11R are both less than a predetermined reference temperature Tm_thr (step S31). Specifically, the battery diagnosis processor 67 acquires information on the temperature Tm1 of the first motor 11L outputted from the first motor temperature sensor 15L provided in the first motor 11L and information on the temperature Tm2 of the second motor 11R outputted from the second motor temperature sensor 15R provided in the second motor 11R. The battery diagnosis processor 67 then determines whether the temperature Tm1 of the first motor 11L and the temperature Tm2 of the second motor 11R are each less than the predetermined reference temperature Tm_thr set in advance. The predetermined reference temperature Tm_thr is set to any appropriate value in accordance with a value of an allowable upper limit temperature.

If the temperature Tm1 of the first motor 11L and the temperature Tm2 of the second motor 11R are both less than the predetermined reference temperature Tm_thr (S31/Yes), the battery diagnosis processor 67 sets each of a current value Im1 to be supplied to the first motor 11L and a current value Im2 to be supplied to the second motor 11R to a value of one-half of the current value Id necessary for the deterioration diagnosis. Then, the first motor 11L and the second motor 11R are counter-torque driven to allow each of the output torques of the first motor 11L and the second motor 11R to be zero (step S33).

Specifically, the battery diagnosis processor 67 controls the driving of the first inverter circuit 13La and the second inverter circuit 13Lb of the first inverter unit 13L, and applies rotational torques of the same magnitude in directions opposite to each other to the rotor 41L of the first motor 11L. Likewise, the battery diagnosis processor 67 controls the driving of the first inverter circuit 13Ra and the second inverter circuit 13Rb of the second inverter unit 13R, and applies rotational torques of the same magnitude in directions opposite to each other to the rotor 41R of the second motor 11R. This makes it possible to cause the battery 20 to discharge an instantaneous current for the deterioration diagnosis with outputs from the first motor 11L and the second motor 11R being maintained at zero, while suppressing an increase in the temperatures of the first motor 11L and the second motor 11R.

If one of the temperature Tm1 of the first motor 11L or the temperature Tm2 of the second motor 11R is not less than the predetermined reference temperature Tm_thr (S31/No), the battery diagnosis processor 67 determines whether the temperature Tm1 of the first motor 11L is less than the predetermined reference temperature Tm_thr (step S35). If the temperature Tm1 of the first motor 11L is less than the predetermined reference temperature Tm_thr (S35/Yes), the battery diagnosis processor 67 sets the current value Im1 to be supplied to the first motor 11L as the current value Id necessary for the deterioration diagnosis, whereas the battery diagnosis processor 67 sets the current value Im2 to be supplied to the second motor 11R to zero. Then, the first motor 11L is counter-torque driven to allow the output torque of the first motor 11L to be zero (step S37). This makes it possible to cause the battery 20 to discharge an instantaneous current for the deterioration diagnosis with outputs from the first motor 11L and the second motor 11R being maintained at zero, while suppressing an increase in the temperature of the second motor 11R.

Meanwhile, if the temperature Tm1 of the first motor 11L is not less than the predetermined reference temperature Tm_thr (S35/No), the battery diagnosis processor 67 determines whether the temperature Tm2 of the second motor 11R is less than the predetermined reference temperature Tm_thr (step S39). If the temperature Tm2 of the second motor 11R is less than the predetermined reference temperature Tm_thr (S39/Yes), the battery diagnosis processor 67 sets the current value Im1 to be supplied to the first motor 11L to zero, whereas the battery diagnosis processor 67 sets the current value Im2 to be supplied to the second motor 11R as the current value Id necessary for the deterioration diagnosis. Then, the second motor 11R is counter-torque driven to allow the output torque of the second motor 11R to be zero (step S41). This makes it possible to cause the battery 20 to discharge an instantaneous current for the deterioration diagnosis with outputs from the first motor 11L and the second motor 11R being maintained at zero, while suppressing an increase in the temperature of the first motor 11L.

Meanwhile, if the temperature Tm2 of the second motor 11R is not less than the predetermined reference temperature Tm_thr (S39/No), the counter-torque driving is not executed on any of the first motor 11L or the second motor 11R in order to prevent the first motor 11L and the second motor from being brought into an overheated state. In this case, the battery diagnosis processor 67 ends the diagnosis process before the start of travel without calculating the internal resistance Rb of the battery 20.

If one or both of the first motor 11L and the second motor 11R are counter-torque driven to cause the battery 20 to discharge in each of steps S33, S37, and S41, the battery diagnosis processor 67 calculates the internal resistance Rb of the battery 20 based on a voltage variable value ΔV (ΔV1 or ΔV2) upon the start of the discharging or upon the end of the discharging (step S43). Specifically, the battery diagnosis processor 67 acquires information on the output voltage of the battery 20 transmitted from the battery management device 21 to determine the voltage variable value ΔV1 at the time when starting the counter-torque driving of one or both of the first motor 11L and the second motor 11R or the voltage variable value ΔV2 at the time when ending the counter-torque driving. Then, the battery diagnosis processor 67 calculates and records the internal resistance Rb (=ΔV/Id) based on the value Id of the current discharged from the battery 20 and the voltage variable value ΔV.

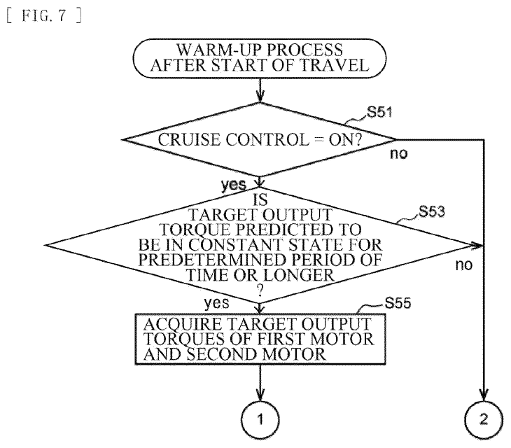

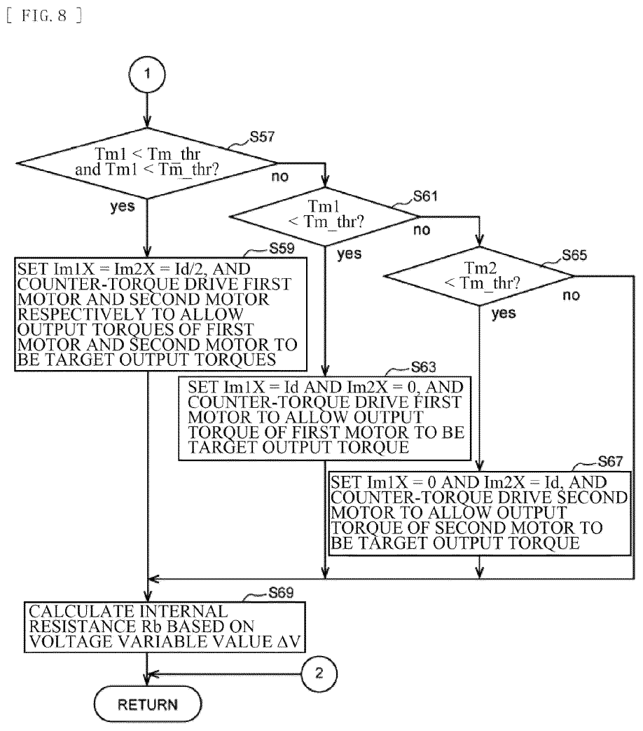

FIGS. 7 to 8 are each a flowchart illustrating an example of the diagnosis process after the start of travel.

After the start of the travel of the vehicle 1, the first motor 11L and the second motor 11R are counter-torque driven to allow driving torques equivalent to the respective target output torques to be outputted from the first motor 11L and the second motor 11R.

The battery diagnosis processor 67 determines whether a cruise control function is activated (step S51). If a preceding vehicle is within a predetermined distance from an own vehicle, the cruise control function causes the own vehicle to automatically follow the preceding vehicle while maintaining an inter-vehicle distance in accordance with a vehicle speed. Meanwhile, if the preceding vehicle is not within the predetermined distance, the cruise control function causes the own vehicle to travel automatedly while maintaining a set vehicle speed. If the cruise control function is not activated (S51/No), the battery diagnosis processor 67 ends the diagnosis process after the start of travel.

Meanwhile, if the cruise control function is activated (S51/Yes), the battery diagnosis processor 67 determines whether the target output torques of the first motor 11L and the second motor 11R are predicted to be in a constant state for a predetermined period of time or longer (step S53). For example, the battery diagnosis processor 67 determines whether the target output torques of the first motor 11L and the second motor 11R are predicted to be in a constant state for a predetermined period of time or longer based on a road shape ahead of the vehicle 1 detected by the surrounding environment detector 65, a circumstance of another vehicle around the vehicle 1, or a speed of the vehicle 1, for example. Specifically, when the vehicle 1, which is traveling straight on a straight road, travels stably at a constant speed without the traveling of the vehicle 1 being hindered, the battery diagnosis processor 67 determines whether the target output torques of the first motor 11L and the second motor 11R are predicted to be in a constant state for a predetermined period of time or longer.

It is to be noted that the battery diagnosis processor 67 may identify the position and the traveling direction of the vehicle 1 on the high-precision map data based on data regarding the position of the vehicle 1 transmitted from the GNSS sensor 59 to determine whether the target output torques of the first motor 11L and the second motor 11R are predicted to be in a constant state for a predetermined period of time or longer, based on the information on the road shape ahead and the speed limit in the traveling direction of the vehicle 1 and based on information on the vehicle speed of the vehicle 1. The high-precision map data may be stored in the storage 53, or may be stored in an external server configured to be coupled via a wireless communication means. In addition, in order to estimate whether the target output torque is varied by the acceleration and deceleration of the vehicle 1, information on traffic congestion may be acquired from an external system.

If it is not predicted that the target output torques of the first motor 11L and the second motor 11R are in a constant state for a predetermined period of time or longer (S53/No), the battery diagnosis processor 67 ends the diagnosis process after the start of travel. Meanwhile, if it is predicted that the target output torques of the first motor 11L and the second motor 11R are in a constant state for a predetermined period of time or longer (S53/Yes), the battery diagnosis processor 67 acquires information on the respective target output torques of the first motor 11L and the second motor 11R (step S55). Specifically, the target torque setting unit 61 sets the respective target output torques of the first motor 11L and the second motor 11R based on the requested driving torque of the vehicle 1. The requested driving torque is calculated based on the amount of operation of the accelerator pedal and the vehicle speed in the manual driving. In addition, the requested driving torque is calculated based on the requested acceleration rate determined by arithmetic operation in the automated driving. The battery diagnosis processor 67 acquires results of the arithmetic operation of the target output torque by the target torque setting unit 61.

Next, similarly to step S31 described above, the battery diagnosis processor 67 determines whether the temperature Tm1 of the first motor 11L and the temperature Tm2 of the second motor 11R are both less than the predetermined reference temperature Tm_thr (step S57). If the temperature Tm1 of the first motor 11L and the temperature Tm2 of the second motor 11R are both less than the predetermined reference temperature Tm_thr (S57/Yes), the battery diagnosis processor 67 sets each of Im1X and a current value Im2X to a value of one-half of the current value Id necessary for the deterioration diagnosis. Im1X is to be added to a value of a current supplied to the first motor 11L, and the current value Im2X is to be added to a value of a current supplied to the second motor 11R. Then, the first motor 11L and the second motor 11R are counter-torque driven to allow the respective output torques of the first motor 11L and the second motor 11R to be the target output torques (step S59).

Specifically, the battery diagnosis processor 67 controls the driving of the first inverter circuit 13La and the second inverter circuit 13Lb of the first inverter unit 13L, and additionally applies rotational torques of the same magnitude in directions opposite to each other to the rotor 41L of the first motor 11L. More specifically, for example, the battery diagnosis processor 67 adds (subtracts) a counter-rotational torque equivalent to a value of one-half of the current value Id necessary for the deterioration diagnosis to (from) the rotational torque of the first stator coil 43La, and adds a forward rotational torque equivalent to a value of one-half of the current value Id necessary for the deterioration diagnosis to the rotational torque of the second stator coil 43Lb. Likewise, the battery diagnosis processor 67 controls the driving of the first inverter circuit 13Ra and the second inverter circuit 13Rb of the second inverter unit 13R, and applies rotational torques of the same magnitude in directions opposite to each other to the rotor 41R of the second motor 11R. This makes it possible to cause the battery 20 to discharge an instantaneous current for the deterioration diagnosis while setting the driving torques outputted from the first motor 11L and the second motor 11R as the target output torques.

Meanwhile, if one of the temperature Tm1 of the first motor 11L or the temperature Tm2 of the second motor 11R is not less than the predetermined reference temperature Tm_thr (S57/No), the battery diagnosis processor 67 determines whether the temperature Tm1 of the first motor 11L is less than the predetermined reference temperature Tm_thr, similarly to step S35 described above (step S61). If the temperature Tm1 of the first motor 11L is less than the predetermined reference temperature Tm_thr (S61/Yes), the battery diagnosis processor 67 sets the current value Im1X to be added to the value of a current supplied to the first motor 11L as the current value Id necessary for the deterioration diagnosis, whereas the battery diagnosis processor 67 sets the current value Im2X to be added to the value of a current supplied to the second motor 11R to zero. Then, the first motor 11L is counter-torque driven to allow the respective output torques of the first motor 11L and the second motor 11R to be the target output torques (step S63). This makes it possible to cause the battery 20 to discharge an instantaneous current for the deterioration diagnosis, while suppressing an increase in the temperature of the second motor 11R and setting the driving torques outputted from the first motor 11L and the second motor 11R as the target output torques.

Meanwhile, if the temperature Tm1 of the first motor 11L is not less than the predetermined reference temperature Tm_thr (S61/No), the battery diagnosis processor 67 determines whether the temperature Tm2 of the second motor 11R is less than the predetermined reference temperature Tm_thr, similarly to step S39 described above (step S65). If the temperature Tm2 of the second motor 11R is less than the predetermined reference temperature Tm_thr (S65/Yes), the battery diagnosis processor 67 sets the current value Im1X to be added to the value of a current supplied to the first motor 11L to zero, whereas the battery diagnosis processor 67 sets the current value Im2X to be added to the value of a current supplied to the second motor 11R as the current value Id necessary for the deterioration diagnosis. Then, the second motor 11R is counter-torque driven to allow the respective output torques of the first motor 11L and the second motor 11R to be the target output torques (step S67). This makes it possible to cause the battery 20 to discharge an instantaneous current for the deterioration diagnosis, while suppressing an increase in the temperature of the first motor 11L and setting the driving torques outputted from the first motor 11L and the second motor 11R as the target output torques.

Meanwhile, if the temperature Tm2 of the second motor 11R is not less than the predetermined reference temperature Tm_thr (S65/No), the counter-torque driving is not executed on any of the first motor 11L or the second motor 11R in order to prevent the first motor 11L and the second motor from being brought into an overheated state. In this case, the battery diagnosis processor 67 ends the diagnosis process after the start of travel without calculating the internal resistance Rb of the battery 20.

If one or both of the first motor 11L and the second motor 11R are counter-torque driven to cause the battery 20 to discharge in each of steps S59, S61, and S65, the battery diagnosis processor 67 calculates the internal resistance Rb of the battery 20 based on the voltage variable value ΔV (ΔV1 or ΔV2) upon the start of the discharging or upon the end of the discharging, similarly to step S43 described above (step S69).

Returning back to FIG. 5, after executing the diagnosis process before the start of travel or the diagnosis process after the start of travel, the battery diagnosis processor 67 determines whether the calculated internal resistance Rb of the battery 20 is equal to or greater than a predetermined threshold (step S23). The threshold is set to any value in advance. If the internal resistance Rb of the battery 20 is less than the predetermined threshold (S23/No), the battery diagnosis processor 67 does not determine that the battery 20 is deteriorated, and ends the battery deterioration diagnosis process. Meanwhile, if the internal resistance Rb of the battery 20 is less than the predetermined threshold (S23/No), the battery diagnosis processor 67 notifies an occupant such as a driver of deterioration of the battery 20 (step S25), and ends the battery deterioration diagnosis process. The notification of the deterioration of the battery 20 may be a notification by voice, or may be a notification by a warning lamp or by image display or text display on a display unit.

As described above, the motor control system 10 according to the present embodiment drives the first inverter circuit 13La (13Ra) and the second inverter circuit 13Lb (13Rb) coupled to each of the first motor 11L and the second motor 11R to apply rotational torques in directions opposite to each other to the rotor 41L (41R) of the first motor 11L and the second motor 11R. Thus, a current corresponding to the rotational torque to be canceled is discharged as an instantaneous current from the battery 20 without changing the output torques from the first motor 11L and the second motor 11R from the target output torques (including zero). Then, the battery diagnosis processor 67 is configured to diagnose the deterioration of the battery 20 based on a variable value of the voltage of the battery 20 at the time when the instantaneous current is discharged from the battery 20. Accordingly, it is possible to increase a degree of freedom of a timing of executing the deterioration diagnosis of the battery 20 without using a load device for discharging.

In addition, in the motor control system 10 according to the present embodiment, the battery diagnosis processor 67 predicts a state where the target output torques of the first motor 11L and the second motor 11R are constant for a predetermined period of time even after the vehicle 1 has started to travel, and counter-torque drives one or both of the first motor 11L and the second motor 11R during the predicted period of time. This makes it possible to detect a voltage variable value due to the discharging of the instantaneous current from the state where the output voltage is stable and thus to accurately detect the internal resistance Rb of the battery 20 based on the voltage variable value and enhance accuracy in the deterioration diagnosis of the battery 20.

### 5. Modification Examples

Although the description has been given heretofore of the motor control system according to the present embodiment, various modifications may be made to the embodiment described above. Description is given below of some of the modification examples.

In addition, in the forgoing embodiment, description has been given by exemplifying the two-wheel drive vehicle including the first motor that drive the left rear wheel and the second motor that drive the right rear wheel. However, the drive system for the electric vehicle is not limited to the example described above. For example, the electric vehicle may be a four-wheel drive vehicle including two motors configured to independently drive front wheels or rear wheels.

In addition, the electric vehicle may be a two-wheel drive vehicle or a four-wheel drive vehicle including one motor that drives one of front wheels or rear wheels or both thereof. In this case, the control apparatus executes the counter-torque driving on one motor to thereby cause the battery to discharge the instantaneous current, thus making it possible to execute the deterioration diagnosis of the battery.

Although preferred embodiments of the disclosure have been described in detail in the foregoing with reference to the accompanying drawings, the disclosure is by no means limited to such embodiments. It is apparent that a person having an ordinary skill in the art to which the disclosure pertains readily arrives at various modifications and alterations within the scope of the technical idea as defined by the appended claims. It should be appreciated that they shall obviously fall within the technical scope of the disclosure as well.

### DESCRIPTION OF REFERENCE NUMERALS

1: Vehicle
10: Motor control system
11L: First motor
11R: Second motor
13L: First inverter unit
13La· 13Ra: First inverter circuit
13Lb·13Rb: Second inverter circuit
13R: Second inverter unit
15L: First motor temperature sensor
15R: Second motor temperature sensor
20: Battery
21: Battery management device
41L-41R: Rotor
43La·43Ra: First stator coil
43Lb·43Rb: Second stator coil
50: Control apparatus
51: Processing unit
53: Storage
57: Vehicle state sensor
61: Target torque setting unit
63: Motor controller
65: Surrounding environment detector
67: Battery diagnosis processor

1. A motor control system for an electric vehicle, the motor control system comprising:
a battery;
a motor comprising a rotor and a stator;
two inverter circuits that are each coupled to the stator and are each configured to control driving and regeneration of the motor; and
a control apparatus configured to control driving of the two inverter circuits, wherein
the control apparatus is configured to
cause the battery to discharge by driving the respective two inverter circuits and applying, to the rotor, rotational torques in directions opposite to each other, and
execute a deterioration diagnosis process of the battery, based on an output current or an output voltage of the battery upon the discharging.

2. The motor control system for the electric vehicle according to claim 1, wherein the control apparatus is configured to cause, to execute the deterioration diagnosis process of the battery, the battery to discharge while maintaining an output torque of the motor at zero by applying, to the rotor, the rotational torques of same magnitude in the directions opposite to each other after activation of the motor control system and before a start of an output of a driving torque from the motor.

3. The motor control system for the electric vehicle according to claim 2, wherein the control apparatus is configured to cause the battery to discharge a predetermined diagnosing current value set in advance necessary for deterioration diagnosis by driving the respective two inverter circuits and applying, to the rotor, the rotational torques in the directions opposite to each other.

4. The motor control system for the electric vehicle according to claim 1, wherein
the control apparatus is configured to
predict a state where a target output torque of the motor is constant for a predetermined period of time or longer, and
cause, to execute the deterioration diagnosis process of the battery, the battery to discharge by applying, to the rotor, the rotational torques in the directions opposite to each other to maintain an output torque from the motor at the target output torque during a period when the target output torque is constant for the predetermined period of time or longer.

5. The motor control system for the electric vehicle according to claim 4, wherein the control apparatus is configured to, when it is predicted that the electric vehicle travels straight for the predetermined period of time or longer and one of an acceleration rate and a deceleration rate does not change during automated driving of the electric vehicle, predict that the target output torque of the motor is in a state of being constant for the predetermined period of time or longer.

6. The motor control system for the electric vehicle according to claim 1, wherein
the control apparatus is configured to
acquire information on a remaining capacity of the battery, and
when the remaining capacity is equal to or greater than a predetermined threshold, execute the deterioration diagnosis process of the battery.

7. An electric vehicle comprising:
a battery;
a motor comprising a rotor and a stator;
two inverter circuits that are each coupled to the stator and are each configured to control driving and regeneration of the motor, and
a control apparatus configured to control driving of the two inverter circuits, wherein
the control apparatus is configured to
cause the battery to discharge by driving the respective two inverter circuits and applying, to the rotor, rotational torques in directions opposite to each other, and
execute a deterioration diagnosis process of the battery, based on an output current or an output voltage of the battery upon the discharging.
